(19) United States
(12) Patent Application Publication
(10) Pub. No.: US 2020/0387993 A1
(43) Pub. Date: Dec. 10, 2020

(54) ANALYZING PASSENGER GENDER ON A RIDESHARING PLATFORM

(71) Applicant: DiDi Research America, LLC, Mountain View, CA (US)

(72) Inventors: Conghui FU, Santa Clara, CA (US); Xin CHEN, Sunnyvale, CA (US); Dong LI, Santa Clara, CA (US); Jing CHEN, Palo Alto, CA (US)

(21) Appl. No.: 16/435,157

(22) Filed: Jun. 7, 2019

(51) Int. Cl. G06Q 50/26; G06Q 50/30; G06Q 30/00

(52) U.S. Cl. CPC G06Q 50/265; G06Q 30/01; G06Q 50/30

(57) ABSTRACT

After obtaining a dictionary comprising mappings of names to genders generated from frequencies of genders of the names, a name (e.g., a user name, a name, or a middle name) of a passenger can be received and a gender of the passenger can be determined. The gender of the passenger can be determined based on: (i) the gender of a mapping of the name of the passenger to a gender, or (ii) the frequencies of the genders for one or more names within a threshold distance of the name of the passenger.

### TECHNICAL FIELD

The disclosure relates generally to ridesharing platforms.

### BACKGROUND

Under traditional approaches, ridesharing platforms may be able to connect passengers and drivers on relatively short notice. However, traditional ridesharing platforms suffer from a variety of safety and security risks for both passengers and drivers.

### SUMMARY

One aspect of the present disclosure is directed to a system for ridesharing. In some embodiments, the system comprises: one or more processors; and a memory storing instructions that, when executed by the one or more processors, cause the system to perform: generating a dictionary comprising a mapping of each of a plurality of first names to a gender of a plurality of genders from a frequency of each of the plurality of genders for each of the plurality of first names. The plurality of names can comprise names used as first names or middle names. The instructions, when executed by the one or more processors, can cause the system to perform: receiving a name of a user, such as a user name, a first name, or a middle name, of a user, such as a passenger or a driver, provided by the user during registration with a ridesharing platform. The instructions, when executed by the one or more processors, can cause the system to perform: determining a gender of the passenger based on: if the dictionary comprises the mapping of the first name of the passenger to a first possible gender of the plurality of genders, (i) the gender of a mapping of the first name of the passenger to a gender of the plurality of genders. The instructions, when executed by the one or more processors, can cause the system to perform: determining a gender of the passenger based on: if the dictionary comprises no mapping of the first name of the passenger to a first possible gender of the plurality of genders, (ii) based on the frequency of each of the plurality of genders for each of one or more first names of the plurality of first names within a threshold distance of the first name of the passenger. The instructions, when executed by the one or more processors, can cause the system to perform: receiving a trip order from the passenger. The instructions, when executed by the one or more processors, can cause the system to perform: determining a risk for the trip order based on the gender of the passenger. The instructions, when executed by the one or more processors, can cause the system to perform: determining a decision for the trip order based on the risk of the trip order.

In some embodiments, the passenger provided no specific gender information during registration with the ridesharing platform.

Another aspect of the present disclosure is directed to a system for gender determination. In some embodiments, the system comprises: one or more processors; and a memory storing instructions that, when executed by the one or more processors, cause the system to perform: obtaining a dictionary comprising a mapping of each of a plurality of first names to a gender of a plurality of genders and a frequency of each of the plurality of genders for each of the plurality of first names. The plurality of names can comprise names used as first names or middle names. The instructions, when executed by the one or more processors, cause the system to perform: receiving a first name of a passenger. The instructions, when executed by the one or more processors, cause the system to perform: determining a gender of the passenger based on: if the dictionary comprises the mapping of the first name of the passenger to a first possible gender of the plurality of genders, (i) the gender of a mapping of the first name of the passenger to a gender of the plurality of genders, else, (ii) the frequency of each of the plurality of genders for each of one or more first names of the plurality of first names within a threshold distance of the first name of the passenger. The instructions, when executed by the one or more processors, cause the system to perform: receiving a new trip order from the passenger. The instructions, when executed by the one or more processors, cause the system to perform: determining a decision for the new trip order based on the income level of the passenger.

In some embodiments, obtaining the dictionary comprising the mapping of each of the plurality of first names to a gender of the plurality genders comprises: obtaining a frequency of each of the plurality of genders for each of the plurality of first names; and generating the mapping of each of the plurality of first names to a gender of the plurality of genders having a highest frequency of the frequencies of all genders of the plurality of genders.

In some embodiments, the instructions, when executed by the one or more processors, cause the system to perform: determining the dictionary comprises the mapping of the first name of the passenger to a gender of the plurality of genders.

In some embodiments, determining the first possible gender of the passenger based on the frequency of each of the plurality of genders of each of the one or more first names of the plurality of first names within the threshold distance of the first name of the passenger comprises: identifying one or more first names of the plurality of first names within the threshold distance of the first name of the passenger; for each gender of the plurality of genders, determining a sum of frequencies of the one or more first names of the plurality of first names within the threshold distance of the first name of the passenger; and determining the first possible gender of the passenger based on, for each gender of the plurality of genders, the sum of frequencies of the one or more first names of the plurality of first names within the threshold distance of the first name of the passenger. Determining the first possible gender of the passenger based on, for each gender of the plurality of genders, the sum of frequencies of the one or more first names of the plurality of first names within the threshold distance of the first name of the passenger can comprise: for each gender of the plurality of genders, determining a fraction of the one or more first names of the plurality of first names within the threshold distance of the first name of the passenger having the gender; and determining the first possible gender of the passenger based on the gender of the plurality of genders having a biggest fraction of the fractions of the one or more first names of the plurality of first names within the threshold distance of the first name of the passenger. Determining the gender of the passenger based on, for each gender of the plurality of genders, the sum of frequencies of the one or more first names of the plurality of first names within the threshold distance of the first name of the passenger can comprise: determining the gender of the passenger based on the gender of the plurality of genders having a biggest sum of the sums of the frequencies of the one or more first names of the plurality of first names within the threshold distance of the first name of the passenger.

In some embodiments, the threshold distance comprises a threshold edit distance. Each of the one or more first names of the plurality of first names within the threshold distance of the first name of the passenger can be transformed to the first name of the passenger using one or more operations comprising an insertion, a deletion, a substitution, or a combination thereof, and a number of the one or more operations is at most the threshold distance. The one or more operations can further comprise a transposition.

In some embodiments, the instructions, when executed by the one or more processors, cause the system to perform: converting one or more characters of the first name of the passenger to a language of the dictionary from another language.

In some embodiments, the first name of the passenger is provided by the passenger during registration with a ridesharing platform.

In some embodiments, the instructions, when executed by the one or more processors, cause the system to perform: receiving identification number information of the passenger provided by the passenger during registration with the ridesharing platform; determining a second possible gender of the passenger based on the identification number information of the passenger; and determining a gender of the passenger based on the first possible gender of the passenger and the second possible gender of the passenger. The identification number information of the passenger comprises a state identification number, a national identification number, a passport number, a credit card number, or a combination thereof. Determining the second possible gender of the passenger based on the identification number information of the passenger comprises: receiving the second possible gender of the passenger from a service provider. The instructions, when executed by the one or more processors, can cause the system to perform: updating the gender of the passenger based on a third possible gender provided by a customer service representative of the ridesharing platform, a fourth driver provided a driver of the ridesharing platform, a fifth possible gender provided by the passenger in a survey, or a combination thereof.

In some embodiments, the instructions, when executed by the one or more processors, cause the system to perform: receiving a sixth possible gender of the passenger provided by the passenger during registration with the ridesharing platform; and determining a gender of the passenger based on the first possible gender of the passenger and the sixth possible gender of the passenger. The passenger can provide no specific gender information during registration with the ridesharing platform.

Another aspect of the present disclosure is directed to a method for gender estimation. In some embodiments, the method comprises: obtaining a dictionary comprising a mapping of each of a plurality of first names to a gender of a plurality of genders and a frequency of each of the plurality of genders for each of the plurality of first names. The plurality of names can comprise names used as first names or middle names. The method can further comprise: receiving a trip order of a passenger. The method can further comprise: determining a gender of the passenger based on: if the dictionary comprises the mapping of the first name of the passenger to a first possible gender of the plurality of genders, (i) the gender of a mapping of the first name of the passenger to a gender of the plurality of genders, else, (ii) the frequency of each of the plurality of genders for each of one or more first names of the plurality of first names within a threshold distance of the first name of the passenger. The method can further comprise: determining a decision for the trip order based on the gender of the passenger.

In some embodiments, obtaining the dictionary comprising the mapping of each of the plurality of first names to a gender of the plurality genders comprises: obtaining a frequency of each of the plurality of genders for each of the plurality of first names; and generating the mapping of each of the plurality of first names to a gender of the plurality of genders having a highest frequency of the frequencies of all genders of the plurality of genders.

In some embodiments, the method further comprises: determining the dictionary comprises the mapping of the first name of the passenger to a gender of the plurality of genders.

In some embodiments, determining the first possible gender of the passenger based on the frequency of each of the plurality of genders of each of the one or more first names of the plurality of first names within the threshold distance of the first name of the passenger comprises: identifying one or more first names of the plurality of first names within the threshold distance of the first name of the passenger; for each gender of the plurality of genders, determining a sum of frequencies of the one or more first names of the plurality of first names within the threshold distance of the first name of the passenger; and determining the first possible gender of the passenger based on, for each gender of the plurality of genders, the sum of frequencies of the one or more first names of the plurality of first names within the threshold distance of the first name of the passenger. Determining the first possible gender of the passenger based on, for each gender of the plurality of genders, the sum of frequencies of the one or more first names of the plurality of first names within the threshold distance of the first name of the passenger can comprise: for each gender of the plurality of genders, determining a fraction of the one or more first names of the plurality of first names within the threshold distance of the first name of the passenger having the gender; and determining the first possible gender of the passenger based on the gender of the plurality of genders having a biggest fraction of the fractions of the one or more first names of the plurality of first names within the threshold distance of the first name of the passenger. Determining the gender of the passenger based on, for each gender of the plurality of genders, the sum of frequencies of the one or more first names of the plurality of first names within the threshold distance of the first name of the passenger can comprise: determining the gender of the passenger based on the gender of the plurality of genders having a biggest sum of the sums of the frequencies of the one or more first names of the plurality of first names within the threshold distance of the first name of the passenger.

In some embodiments, the threshold distance comprises a threshold edit distance. Each of the one or more first names of the plurality of first names within the threshold distance of the first name of the passenger can be transformed to the first name of the passenger using one or more operations comprising an insertion, a deletion, a substitution, or a combination thereof, and a number of the one or more operations is at most the threshold distance. The one or more operations can further comprise a transposition.

In some embodiments, the method further comprises: converting one or more characters of the first name of the passenger to a language of the dictionary from another language.

In some embodiments, the first name of the passenger is provided by the passenger during registration with a ridesharing platform.

In some embodiments, the method further comprises: receiving identification number information of the passenger provided by the passenger during registration with the ridesharing platform; determining a second possible gender of the passenger based on the identification number information of the passenger; and determining a gender of the passenger based on the first possible gender of the passenger and the second possible gender of the passenger. The identification number information of the passenger can comprise a state identification number, a national identification number, a passport number, a credit card number, or a combination thereof. Determining the second possible gender of the passenger based on the identification number information of the passenger can comprise: receiving the second possible gender of the passenger from a service provider. The method can further comprise: updating the gender of the passenger based on a third possible gender provided by a customer service representative of the ridesharing platform, a fourth driver provided a driver of the ridesharing platform, a fifth possible gender provided by the passenger in a survey, or a combination thereof.

In some embodiments, the method can further comprise: receiving a sixth possible gender of the passenger provided by the passenger during registration with the ridesharing platform; and determining a gender of the passenger based on the first possible gender of the passenger and the sixth possible gender of the passenger. The passenger can provide no specific gender information during registration with the ridesharing platform.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment for a ridesharing platform system, in accordance with various embodiments of the disclosure.

FIG. 2 illustrates an example environment of a ridesharing platform system, in accordance with various embodiments of the disclosure.

FIG. 3 illustrates an example workflow for determining a gender of a passenger, in accordance with various embodiments of the disclosure.

FIG. 4 is a flowchart of an example method for determining a gender of a passenger, in accordance with various embodiments of the disclosure.

FIG. 5 is a block diagram of an example computer system in which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may improve the safety and security of a ridesharing service. More specifically, for example, the approaches disclosed herein enable and/or improve driver and passenger safety in a ridesharing service, for example, by determining passenger's gender and determining the risk of a trip order using the passenger's gender. Incidents can make a trip unsafe. Incidents can include physical incidents (e.g., property losses and physical harms to drivers and passengers). Gender information of passengers is needed to protect passengers, such as female passengers, of a ridesharing platform. Passengers may not provide their specific gender information to the ridesharing platform at all or may provide incorrect gender information to the ridesharing platform. The ridesharing platform cannot ask for the gender information of passengers when the passengers register with the ridesharing platform (e.g., using an App of the ridesharing platform) in some circumstances. The ridesharing platform may not ask the passengers for specific gender information during registration to improve the user experience during registration.

The actual genders of passengers can be determined based on the passengers' user names (e.g., first names). For example, a ridesharing platform system can generate a dictionary comprising mappings of first names to genders from frequencies of genders of the first names. The ridesharing platform system can receive a first name of a passenger determine a gender of the passenger. The ridesharing platform system can determine the gender of the passenger based on: (i) the gender of a mapping of the first name of the passenger to a gender, or (ii) the frequencies of the genders for one or more first names within a threshold distance of the first name of the passenger. A decision on a trip order by the passenger can be determined based on the likelihood of an incident occurring with the passenger as the perpetrator and the driver being the victim, which in turn can be determined based on the passenger's gender.

### Passenger, Driver, and Ridesharing Platform System Interactions

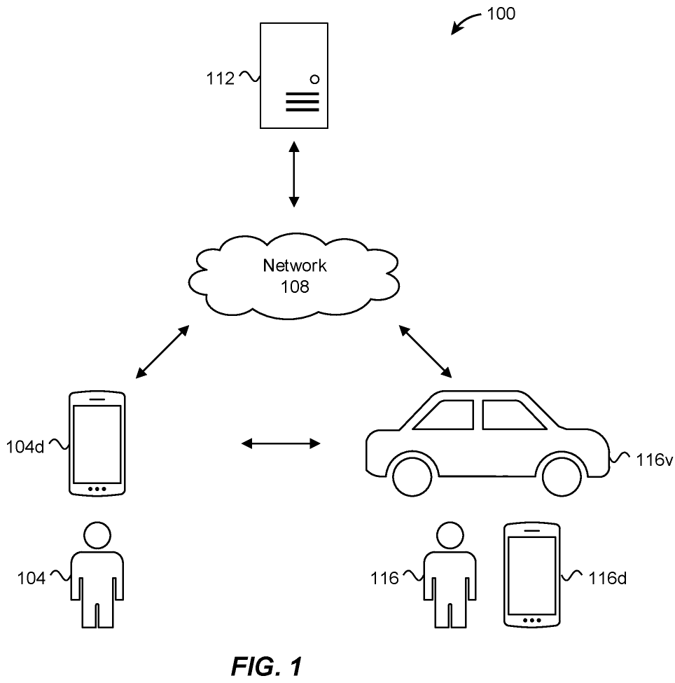

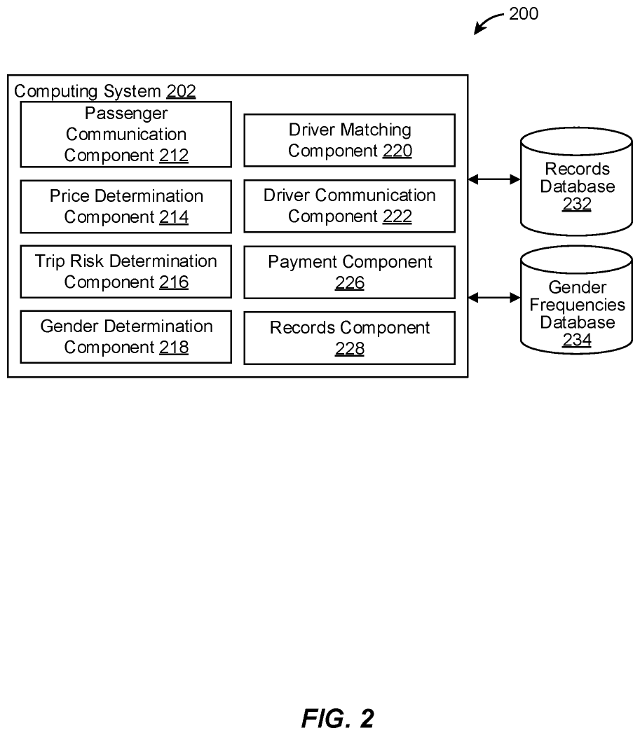

FIG. 1 illustrates an example environment for a ridesharing platform system. In the environment 100 illustrates in FIG. 1, a passenger 104 uses a passenger device 104d (e.g., a smartphone, a tablet, or a computer) to make a trip request, via a communication network 108 (e.g., the Internet) to a ridesharing platform system 112 (such as the computing system 200 described with reference to FIG. 2). The ridesharing platform system 112 can in turn assign a driver 116 and the driver's vehicle 116 (e.g., a car, a SUV, and a truck) to fulfil the trip request. The driver 116 can receive and accept or decline the trip request using a driver device 116d (e.g., a smartphone, a tablet, or a computer). The driver device 116d can be a standalone device or part of the driver's vehicle 116.

During an onboarding process, the passenger 104 and the driver 116 can provide personal information to the ridesharing platform system 112. Stringent background checks can increase driver safety and passenger safety. The passenger 104 can provide the ridesharing platform system 112 with a pickup or starting location and a drop off or destination location of a trip and receive pricing information (e.g., the estimated cost of the trip) and timing information (e.g. the estimated duration of the trip). If the pricing information and timing information are acceptable to the passenger 104, the passenger 104 can make a trip request or place an order (e.g., by clicking an order button) to the ridesharing platform system 112. After receiving the trip request from the passenger 104, the ridesharing platform system 112 can decide whether to accept the trip request and assign or match the driver 116 to the passenger for the particular trip request. Declining or rejecting a trip request of a passenger determined to be likely an offender in an incident can increase driver safety. The driver 116 can proceed to and arrive at the pickup location, where the passenger 104 can enter the driver's vehicle 116v and be transported, by the driver 116 using the vehicle 116v, to the drop off location of the trip request or order. The passenger 104 can pay (e.g., with cash or via the ridesharing platform system 112) the driver 116 after arrival at the drop off location.

Using the passenger device 104d, the passenger 104 can interact with the ridesharing platform system 112 and request ridesharing services. For example, the passenger 140, using the passenger device 104d, can make a trip request to the ridesharing platform system 112. A trip request can include rider identification information, the number of passengers for the trip, a requested type of the provider (e.g., a vehicle type or service option identifier), the pickup location (e.g., a user-specified location, or a current location of the passenger device 104d as determined using, for example, a global positioning system (GPS) receiver), and/or the destination for the trip.

The passenger device 104d can interact with the ridesharing platform system 112 through a client application configured to interact with the ridesharing platform system 112. The client application can present information, using a user interface, received from the ridesharing platform system 112 and transmit information to the ridesharing platform system 112. The information presented on the user interface can include driver-related information, such as driver identity, driver vehicle information, driver vehicle location, and driver estimated arrival. The information presented on the user interface can include the drop off location, a route from the pickup location to the drop off location, an estimated trip duration, an estimated trip cost, and current traffic condition. The passenger device 104d can include a location sensor, such as a global positioning system (GPS) receiver, that can determine the current location of the passenger device 104d. The user interface presented by the client application can include the current location of the passenger device 104. The information transmitted can include a trip request, a pickup location, and a drop off location.

The ridesharing platform system 112 can allow the passenger 104 to specify parameters for the trip specified in the trip request, such as a vehicle type, a pick-up location, a trip destination, a target trip price, and/or a departure timeframe for the trip. The ridesharing platform system 112 can determine whether to accept or reject the trip request and, if so, assign or attempt to assign the driver 116 with the driver vehicle 116v and the driver device 116d to the passenger 104 and the passenger's trip request. For example, the ridesharing platform system 112 can receive a trip request from the passenger device 104d, select a driver from a pool of available drivers to provide the trip, and transmit an assignment request to the selected driver's device 116d.

The driver 116 can interact with, via the driver device 116d, the ridesharing platform system 112 to receive an assignment request to fulfill the trip request. The driver can decide to start receiving assignment requests by going online (e.g., launching a driver application and/or providing input on the driver application to indicate that the driver is receiving assignments), and stop receiving assignment requests by going offline. The driver 116 can receive, from the ridesharing platform system 112, an assignment request to fulfill a trip request made by the passenger using the passenger device 104d to the ridesharing platform system 112. The driver 116 can, using the driver device 116d, accepting or reject the assignment request. By accepting the assignment request, the driver 116 and the driver's vehicle 116v is assigned to the particular trip of the passenger 104, and is provided the passenger's pickup location and trip destination.

The driver device 116d can interact with the ridesharing platform system 112 through a client application configured to interact with the ridesharing platform system 112. The client application can present information, using a user interface, received from the ridesharing platform system 112 (e.g., an assignment request, a pickup location, a drop off location, a route from the pickup location to the drop off location, an estimated trip duration, current traffic condition, and passenger-related information, such as passenger name and gender) and transmit information to the ridesharing platform system 112 (e.g., an acceptance of an assignment request). The driver device 116d can include a location sensor, such as a global positioning system (GPS) receiver, that can determine the current location of the driver device 116d. The user interface presented by the client application can include the current location of the driver device 116 and a route from the current location of the driver device 116 to the pickup location. After accepting the assignment, the driver 116, using the driver's vehicle 116v, can proceed to the pickup location of the trip request to pick up the passenger 104.

The passenger device 104d and the driver device 116d can communicate with the ridesharing platform system 112 via the network 108 The network 108 can include one or more local area and wide area networks employing wired and/or wireless communication technologies (e.g., 3G, 4G, and 5G), one or more communication protocols (e.g., transmission control protocol/Internet protocol (TCP/IP) and hypertext transport protocol (HTTP)), and one or more formats (e.g., hypertext markup language (HTML) and extensible markup language (XML).

### Passenger Gender Determination

FIG. 2 illustrates an example environment 200 for a ridesharing platform system, in accordance with various embodiments. The example environment 200 may include a ridesharing computing system 202. The computing system 202 may include one or more processors and memory (e.g., permanent memory, temporary memory). The processor(s) may be configured to perform various operations by interpreting machine-readable instructions stored in the memory. The computing system 202 may include other computing resources. The computing system 202 may have access (e.g., via one or more connections, via one or more networks) to other computing resources.

The computing system 202 may include a passenger communication component 212, a price determination component 214, a trip risk determination component 216, a gender determination component 218, a driver matching component 220, a driver communication component 224, a payment component 226, and a trip records component 228. The computing system 202 may include other components. While the computing system 202 is shown in FIG. 2 as a single entity, this is merely for ease of reference and is not meant to be limiting. One or more components or one or more functionalities of the computing system 202 described herein may be implemented in software. One or more components or one or more functionalities of the computing system 202 described herein may be implemented in hardware. One or more components or one or more functionalities of the computing system 202 described herein may be implemented in a single computing device or multiple computing devices. In some embodiments, one or more components or one or more functionalities of the computing system 202 described herein may be implemented in one or more networks (e.g., enterprise networks), one or more endpoints, one or more servers, or one or more clouds.

A passenger, such as the passenger 104 described with reference to FIG. 1 (or a passenger's device, such as the passenger device 104 described with reference to FIG. 1) can communicate with the ridesharing computing system 202 via the passenger communication component 212. For example, during the trip request process, the passenger can provide personal information to the ridesharing computing system 202 via the passenger communication component 212. For example, the passenger can provide the ridesharing computing system 202, via the passenger communication component 212, with a pickup location and a drop off location of a trip. For example, the passenger communication component 212 can provide the passenger with pricing information of the trip (e.g., the estimated cost of the trip) and timing information of the trip (e.g. the estimated duration of the trip). If the pricing information and timing information are acceptable to the passenger, the passenger can make a trip request or place an order (e.g., by clicking an order button) to the ridesharing computing system 202, via the passenger communication component 212. After receiving the trip request from the passenger, the ridesharing computing system 202 can determine whether to accept or decline the trip request or order based on a risk of the trip determined by the risk determination component 216. The risk determination component 216 can determine the risk of the trip using the gender identity of the passenger determined by the gender determination component 218. If the risk is acceptable (e.g., below a threshold level), the ridesharing computing system 202 can assign or match the driver to the passenger for the particular trip request using the driver matching component 220. The ridesharing computing system 202, using the driver communication component 224, can provide the assigned driver with an assignment of the trip request. The ridesharing computing system 202, using the driver communication component 224, can receive the driver's acceptance of the assignment of the trip request. The driver communication component 224 can provide the driver with information relating to the progress of the trip, such as the driver's distances from the pickup location and drop off location and a route from the pickup location to the drop off location. The ridesharing computing system 202, using the payment component 226, can receive the passenger's payment for the trip. The records component 228 can store information related to the trip (e.g., the driver information) in the records database 232. The records database 232 can also store the passenger information and the driver information (e.g., received during the registration process, such as the passenger's name, or trip request process).

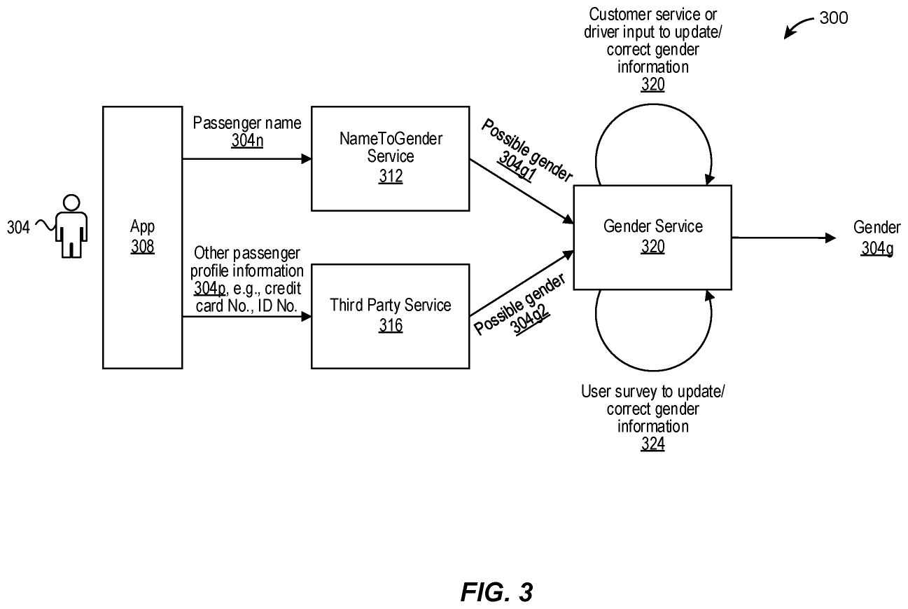

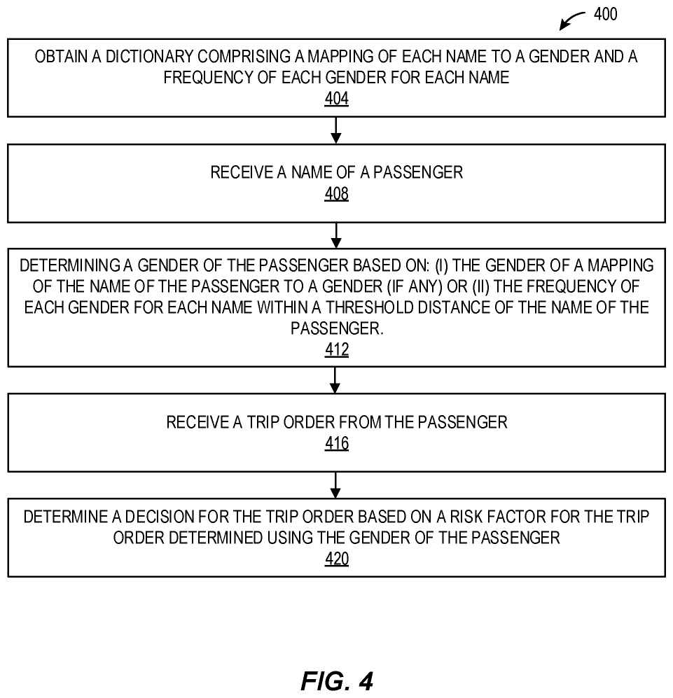

FIG. 3 illustrates an example workflow for determining a gender of a passenger, in accordance with various embodiments of the disclosure. The gender determination component 216 can determine the gender of a passenger as illustrated in the workflow 300 in FIG. 3. Additionally or alternatively, the gender determination component 216 can determine the gender of a passenger using the method 400 described with reference to FIG. 4. Referring to FIG. 3, the gender determination component 216 can determine the gender 304g of a passenger 304, directly or indirectly, from various sources. Example sources can include passenger information provided by the passenger 304 during registration. For example, the passenger 304 can register with the ridesharing platform system via an App 308 of the ridesharing platform system and can provide a name 304n (e.g., a user name, a first name, a middle name, or a nick name) to the ridesharing platform system 202 during registration. For example, the gender determination component 216 can use or implement a NameToGender Service 312 in FIG. 3 to determine a possible gender 304g1 of the passenger 304 from the name 304n of the passenger 304. The gender determination component 216 can determine the gender 304g of the passenger based on the possible gender 304g2 of the passenger 304 determined using passenger profile information 304p. For example, the passenger 304 can provide passenger profile information 320, such as the passenger's credit card number, the passenger's state or federal identification number, to the ridesharing platform system during registration. A third party service 324 can determine a possible gender 304g2 of the passenger using the passenger profile information 304p. The gender determination component 216 can implement or use a Gender Service 320 to determine the gender 304g of the passenger 304g. The Gender Service 320 can determine the gender 304 of the passenger 304g using the possible gender 304g1 determined from the name 312 of the passenger 304 and the possible gender 304g2 determined from other passenger profile information 320. For example, the Gender Service 320 can determine the gender 304g of the passenger 304 to be female if both possible genders 304g1, 304g2 determined are female. As another example, the Gender Service 320 can determine the gender 304g of the passenger 304 to be female if the NameToGender Service 3212 determines the possible gender 304g1 of the passenger 304 is female. For example, the Gender Service 320 can determine the gender 304g of the passenger to be female with 50% confidence if one of the two possible genders 304g1, 304g2 determined is a female.

In some embodiments, the Gender Service 320 can update the gender 304g of the passenger 304 (or increase the confidence of a gender 304 determined) based on input from a customer service representative or a driver 320. For example, a customer service representative can have a conversation with the passenger and determine a possible gender of the passenger 304. As another example, a driver can provide transportation service (e.g., a ride) to the passenger 304 and determine a possible gender of the passenger 304. The determination of the gender of a passenger 304 by a customer service representation can affect (e.g., increase or decrease) the confidence of the gender 304g determined, for example, using the possible genders 304g1, 304g2 determined using the passenger name 304n and the passenger profile information 304p. Alternatively or additionally, the determination of the gender of a passenger 304 by a driver who has provided transportation service to the passenger 304 can affect (e.g., increase or decrease) the confidence of the gender 304g determined. The determination of the gender of a passenger 304 by a driver who has provided transportation service to the passenger 304 can be determinative or affect the confidence of the gender 304g determined substantially because of the face-to-face interaction between the driver and the passenger 304. For example, the passenger 304 can provide specific gender information (e.g., male or female in response to a survey (e.g., an online survey or an offline survey). Only some passengers who receive requests to complete surveys may complete the surveys and provide specific gender information.

In determining the gender of a passenger, the NameToGender Service 312 (or the gender determination component 218) prepares a dictionary comprising a mapping of each name (e.g., a name that can be used as a first name or a middle name) to a gender (e.g., male or female). The NameToGender Service 312 can may acquire, analyze, determine, examine, identify, load, locate, obtain, open, receive, retrieve, and/or review the dictionary. The NameToGender Service 312 can may acquire, analyze, determine, examine, identify, load, locate, obtain, open, receive, retrieve, and/or review a frequency of each gender for each name. The NameToGender Service 312 can access such frequency information from one or more locations. For example, the NameToGender Service 312 can access the frequency information from a storage location, such as an electronic storage of the computing system 202 in FIG. 2 (e.g., the gender frequencies database 234 in FIG. 2), an electronic storage of a device accessible via a network, another computing device/system (e.g., desktop, laptop, smartphone, tablet, mobile device), or other locations.

The NameToGender Service 312 can create a dictionary with a name-to-gender mapping for each name. For example, the NameToGender Service 312 can create a data structure (e.g., table) of mappings of names (e.g., names that can be used as first names or middle names) to genders (e.g., male or female). In the Example shown in Table 1, Rita appears 11 times as female, and 2390 times as male.

TABLE 1
Frequency Table of Name-To-Gender Mappings

| First Name | Female Number | Male Number |
|---|---|---|
| Gilberto | 1 | 5097 |
| Eduardo | 1 | 4426 |
| . | | |
| . | | |
| . | | |
| Rita | 2390 | 11 |
| Aparecida | 2273 | 6 |
| . | | |
| . | | |
| . | | |

Based on Table 1, a dictionary of mappings of names to one gender can be generated using a female ratio equation, such as Equation I.

$$Female Ratio = \frac{{\sum }_{i}^{n} female number}{{\sum }_{i}^{n} male number + {\sum }_{i}^{n} femal number} . \qquad I$$

In the dictionary, one name is mapped to one gender. Table 2 shows an example dictionary of mappings of names to one gender each. In some embodiments, different areas or different countries can have different dictionaries.

TABLE 2
Dictionary of Mappings of Names to One Gender Each

| First Name | Gender |
|---|---|
| Gilberto | Male |
| Eduardo | Male |
| . | |
| . | |
| . | |
| Rita | Female |
| Aparecida | Female |
| . | |
| . | |
| . | |

The NameToGender Service 312 can determine a gender 304g1 from a passenger name 304n. In some embodiments, the NameToGender Service 312 can perform preprocessing. For example, the NameToGender Service 312 can convert characters of the passenger name 312 not in the language of the dictionary to the language of the dictionary. The NameToGender Service 312 can convert non-English characters (e.g., Spanish characters) to English characters. As another example, the NameToGender Service 312 can convert characters of the passenger name 312 into universal representations. The NameToGender Service 312 can determine the gender 304g1 of the passenger 304 using the passenger name 304n. If the dictionary includes a mapping for the passenger name 304n (e.g., “Amy”), the NameToGender Service 312 can determine the gender 304g1 of the passenger 304 to be the gender (e.g., female) of the mapping for the passenger name. If the dictionary does not include a mapping for the exact passenger name 304n, the NameToGender Service 312 can perform fuzzy matching for the passenger name 304n to determine the gender 304g1 for the passenger name 304n. The NameToGender Service 312 can identify names with gender frequency information that are within a threshold distance (e.g., an edit distance of one or two, such as the Damerau or the Damerau-Levenshtein distance) and use the gender frequencies associated with the names within the distance to determine the gender 304g1 for the passenger 304. The NameToGender Service 312 can determine the gender 304g1 of the passenger 304 using the gender frequencies associated with the names and Equation I. For example, the dictionary includes no mapping for the name “Ami.” Gender frequency information is available for names similar to “Ami,” such as “Amy,” “Cami,” and “Camy” that are within a distance of two of the name “Ami.” Table 3 shows example gender frequencies associated with the names within a distance of two of the name “Ami.”

TABLE 3
Gender Frequency Information for Names Similar to “Ami”

| First Name | Female Number | Male Number |
|---|---|---|
| Amy | 1010 | 122 |
| Cami | 3020 | 311 |
| Gamy | 1 | 1000 |
| . | | |
| . | | |
| . | | |
| Total | 10023 | 5215 |

Based on the gender information in Table 3 and Equation 1, the female ratio can be determined to be

$$\frac{10023}{5215 + 10023} = 65.8 \% .$$

The NameToGender Service 312 can determine the gender 304g1 of the passenger 304 to be female based on the female ratio for Ami that is greater than 50%.

In some embodiments, the NameToGender Service 312 generates a data structure (e.g., a table, such as Table 4) with mappings of names to one gender each and the gender frequency information of names.

TABLE 4
Name to Gender Mappings and Gender Frequency Information

| First Name | Gender | Female Number | Male Number |
|---|---|---|---|
| Name₁ | Gender₁ | Female Number₁ | Male Number₁ |
| Name₂ | Gender₂ | Female Number₂ | Male Number₂ |
| Name₃ | Gender₃ | Female Number₃ | Male Number₃ |
| . | | | |
| . | | | |
| . | | | |

### Passenger Gender Determination Method

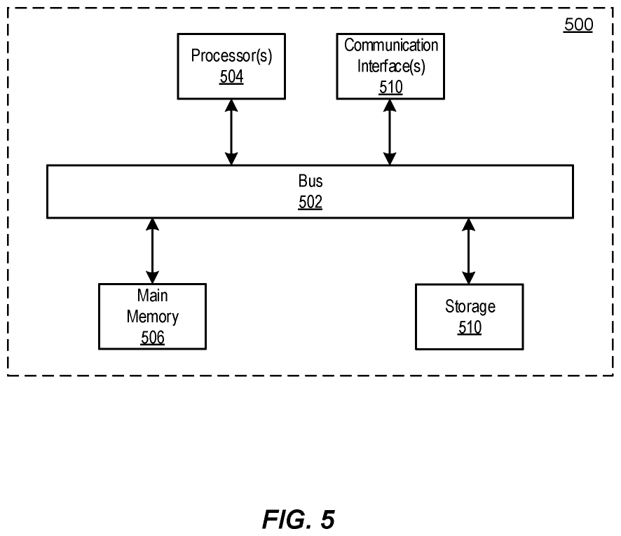

FIG. 4 illustrates a flowchart of an example method 400, according to various embodiments of the present disclosure. The method 400 may be implemented in various environments including, for example, the environment 200 of FIG. 2 and by computer systems, such as the computer system 202 of FIG. 2 or the computer system 500 of FIG. 5. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 404, a computer system, such as the computer system 202 of FIG. 2 or the computer system 500 of FIG. 5, can obtain a dictionary comprising a mapping of each of a plurality of names (e.g., a user name, a first name, a middle name, a nick name) to a gender of a plurality of genders (e.g. male and female) and a frequency of each of the plurality of genders for each of the plurality of names. In some embodiments, to obtaining the dictionary comprising the mapping of each of the plurality of names to a gender of the plurality genders, the computing system can: obtain a frequency of each of the plurality of genders for each of the plurality of names; and generate the mapping of each of the plurality of names to a gender of the plurality of genders having a highest frequency of the frequencies of all genders of the plurality of genders.

With respect to the method 400, at block 408, the computer system can receive a name of a user, such as the name of a passenger or a driver. In some embodiments, the name of the user is provided by the user during registration with a ridesharing platform. In some embodiments, the computing system can: convert one or more characters of the name of the user to a language of the dictionary from another language. In some embodiments, the user provided no specific gender information during registration with the ridesharing platform.

With respect to the method 400, at block 412, the computer system can determine a gender of the user based on: if the dictionary comprises the mapping of the name of the user to a first possible gender of the plurality of genders, (i) the gender of a mapping of the name of the user to a gender of the plurality of genders, else, (ii) the frequency of each of the plurality of genders for each of one or more names of the plurality of names within a threshold distance of the name of the user.

In some embodiments, the computing system can: determine the dictionary comprises the mapping of the name of the user to a gender of the plurality of genders. In some embodiments, the computing system can: determine the plurality of names comprises the name of the user.

In some embodiments, to determine the first possible gender of the user based on the frequency of each of the plurality of genders of each of the one or more names of the plurality of names within the threshold distance of the name of the user, the computing system can: identify one or more names of the plurality of names within the threshold distance of the name of the user. The computing system can: for each gender of the plurality of genders, determine a sum of frequencies of the one or more names of the plurality of names within the threshold distance of the name of the user. The computing system can: determine the first possible gender of the user based on, for each gender of the plurality of genders, the sum of frequencies of the one or more names of the plurality of names within the threshold distance of the name of the user. In some embodiments, to determine the first possible gender of the user based on, for each gender of the plurality of genders, the sum of frequencies of the one or more names of the plurality of names within the threshold distance of the name of the user, the computing system can: for each gender of the plurality of genders, determine a fraction of the one or more names of the plurality of names within the threshold distance of the name of the user having the gender. The computing system can: determine the first possible gender of the user based on the gender of the plurality of genders having a biggest fraction of the fractions of the one or more names of the plurality of names within the threshold distance of the name of the user. In some embodiments, to determine the gender of the user based on, for each gender of the plurality of genders, the sum of frequencies of the one or more names of the plurality of names within the threshold distance of the name of the user, the computing system can: determine the gender of the user based on the gender of the plurality of genders having a biggest sum of the sums of the frequencies of the one or more names of the plurality of names within the threshold distance of the name of the user.

In some embodiments, the threshold distance comprises a threshold edit distance. The distance between the name of the user and a name of the plurality of names within the threshold distance of the name of the user can be the Damerau distance (which is the total number of zero, one, or more insertions; zero, one, or more deletions; and zero, one, or more substitutions to transform the name of the user and the name within the threshold distance of the name of the user). The distance between the name of the user and a name of the plurality of names within the threshold distance of the name of the user can be the Damerau-Levenshtein distance (which is the total number of zero, one, or more insertions; zero, one, or more deletions; zero, one, or more substitutions; and zero, one, or more transpositions to transform the name of the user and the name within the threshold distance of the name of the user). Each of the one or more names of the plurality of names within the threshold distance of the name of the user can be transformed to the name of the user using one or more operations comprising an insertion, a deletion, a substitution, or a combination thereof. A number of the one or more operations is at most the threshold distance. The one or more operations can further comprise a transposition.

In some embodiments, the computing system can: receive identification number information of the user provided by the user during registration with the ridesharing platform. The computing system can: determine a second possible gender of the user based on the identification number information of the user. The computing system can: determine a gender of the user based on the first possible gender of the user and the second possible gender of the user. The identification number information of the user can comprise a state identification number, a national identification number, a passport number, a credit card number, or a combination thereof. To determining the second possible gender of the user based on the identification number information of the user, the computing system can: receive the second possible gender of the user from a service provider.

In some embodiments, the computing system can: update the gender of the user based on a third possible gender provided by a customer service representative of the ridesharing platform. In some embodiments, the computing system can: update the gender of the user based on a fourth driver provided a driver of the ridesharing platform. In some embodiments, the computing system can: update the gender of the user based on a fourth possible gender provided by the user in a survey.

In some embodiments, the computing system can: receive a sixth possible gender of the user provided by the user during registration with the ridesharing platform. The computing system can: determine a gender of the user based on the first possible gender of the user and the sixth possible gender of the user.

With respect to the method 400, at block 416, the computer system can optionally receive a trip order (or a trip request) from the passenger. With respect to the method 400, at block 420, the computer system can optionally determine a decision for the trip order based on the gender of the passenger. The computer system can determine the decision for the trip order based on the risk for the driver for the trip order. The risk for the driver can be determined based on the gender of the passenger. The risk for the driver can be determined based on the passenger's prior behavior, such as the number of recent trip orders, the number of recent canceled trip orders, and driver identities and car models of the recent trip orders and canceled trip orders. The risk for the driver can be determined based on the pickup location, the drop off location, the pickup time, the estimated drop off time, the estimated trip duration of the trip order, and the estimated route for the trip order. The risk for the driver can be determined based on the review of the passenger by drivers who have provided transportation services for the passenger. The decision for the trip order can be an acceptance of the trip order and a decline of the trip order. The decision for the trip order can be a particular driver to assign to the trip order.

### Computer System

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein. For example, the process/method shown in FIG. 4 and described in connection with this figure may be implemented by computer program instructions stored in main memory 506. When these instructions are executed by processor(s) 504, they may perform the steps as shown in FIG. 4 and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may comprise instructions which may program or configure the computing system 102 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A system for ridesharing, the system comprising:
one or more processors; and
a memory storing instructions that, when executed by the one or more processors, cause the system to perform:
generating a dictionary comprising a mapping of each of a plurality of names to a gender of a plurality of genders from a frequency of each of the plurality of genders for each of the plurality of names, the plurality of names comprises names used as first names or middle names;
receiving a name of a passenger provided by the passenger during registration with a ridesharing platform;
determining a gender of the passenger based on:
if the dictionary comprises the mapping of the name of the passenger to a first possible gender of the plurality of genders, (i) the gender of a mapping of the name of the passenger to a gender of the plurality of genders,
else, (ii) the frequency of each of the plurality of genders for each of one or more names of the plurality of names within a threshold distance of the name of the passenger.
receiving a trip order from a passenger;
determining a risk for the trip order based on the gender of the passenger; and
determining a decision for the trip order based on the risk of the trip order.

2. The system of claim 1, wherein the passenger provided no specific gender information during registration with the ridesharing platform.

3. A system comprising:
one or more processors; and
a memory storing instructions that, when executed by the one or more processors, cause the system to perform:
obtaining a dictionary comprising a mapping of each of a plurality of names to a gender of a plurality of genders and a frequency of each of the plurality of genders for each of the plurality of names;
receiving a name of a passenger;
determining a gender of the passenger based on:
if the dictionary comprises the mapping of the name of the passenger to a first possible gender of the plurality of genders, (i) the gender of a mapping of the name of the passenger to a gender of the plurality of genders,
else, (ii) the frequency of each of the plurality of genders for each of one or more names of the plurality of names within a threshold distance of the name of the passenger;
receiving a new trip order from the passenger; and
determining a decision for the new trip order based on the income level of the passenger.

4. The system of claim 3, wherein obtaining the dictionary comprising the mapping of each of the plurality of names to a gender of the plurality genders comprises:
obtaining a frequency of each of the plurality of genders for each of the plurality of names; and
generating the mapping of each of the plurality of names to a gender of the plurality of genders having a highest frequency of the frequencies of all genders of the plurality of genders.

5. The system of claim 3, wherein the instructions, when executed by the one or more processors, cause the system to perform:
determining the dictionary comprises the mapping of the name of the passenger to a gender of the plurality of genders.

6. The system of claim 3, wherein determining the first possible gender of the passenger based on the frequency of each of the plurality of genders of each of the one or more names of the plurality of names within the threshold distance of the name of the passenger comprises:
identifying one or more names of the plurality of names within the threshold distance of the name of the passenger;
for each gender of the plurality of genders, determining a sum of frequencies of the one or more names of the plurality of names within the threshold distance of the name of the passenger; and
determining the first possible gender of the passenger based on, for each gender of the plurality of genders, the sum of frequencies of the one or more names of the plurality of names within the threshold distance of the name of the passenger.

7. The system of claim 6, wherein determining the first possible gender of the passenger based on, for each gender of the plurality of genders, the sum of frequencies of the one or more names of the plurality of names within the threshold distance of the name of the passenger comprises:
for each gender of the plurality of genders, determining a fraction of the one or more names of the plurality of names within the threshold distance of the name of the passenger having the gender; and
determining the first possible gender of the passenger based on the gender of the plurality of genders having a biggest fraction of the fractions of the one or more names of the plurality of names within the threshold distance of the name of the passenger.

8. The system of claim 6, wherein determining the gender of the passenger based on, for each gender of the plurality of genders, the sum of frequencies of the one or more names of the plurality of names within the threshold distance of the name of the passenger comprises:
determining the gender of the passenger based on the gender of the plurality of genders having a biggest sum of the sums of the frequencies of the one or more names of the plurality of names within the threshold distance of the name of the passenger.

9. The system of claim 3, wherein the threshold distance comprises a threshold edit distance.

10. The system of claim 3, wherein each of the one or more names of the plurality of names within the threshold distance of the name of the passenger is transformable to the name of the passenger using one or more operations comprising an insertion, a deletion, a substitution, or a combination thereof, and wherein a number of the one or more operations is at most the threshold distance.

11. The system of claim 10, wherein the one or more operations further comprises a transposition.

12. The system of claim 3, wherein the instructions, when executed by the one or more processors, cause the system to perform:
converting one or more characters of the name of the passenger to a language of the dictionary from another language.

13. The system of claim 3, wherein the name of the passenger is provided by the passenger during registration with a ridesharing platform.

14. The system of claim 13, wherein the instructions, when executed by the one or more processors, cause the system to perform:
receiving identification number information of the passenger provided by the passenger during registration with the ridesharing platform;
determining a second possible gender of the passenger based on the identification number information of the passenger; and
determining a gender of the passenger based on the first possible gender of the passenger and the second possible gender of the passenger.

15. The system of claim 14, wherein the identification number information of the passenger comprises a state identification number, a national identification number, a passport number, a credit card number, or a combination thereof.

16. The system of claim 14, determining the second possible gender of the passenger based on the identification number information of the passenger comprises:
receiving the second possible gender of the passenger from a service provider.

17. The system of claim 13, wherein the instructions, when executed by the one or more processors, cause the system to perform:
updating the gender of the passenger based on a third possible gender provided by a customer service representative of the ridesharing platform, a fourth possible gender provided a driver of the ridesharing platform, a fifth possible gender provided by the passenger in a survey, or a combination thereof.

18. The system of claim 13, wherein the instructions, when executed by the one or more processors, cause the system to perform:
receiving a sixth possible gender of the passenger provided by the passenger during registration with the ridesharing platform; and
determining a gender of the passenger based on the first possible gender of the passenger and the sixth possible gender of the passenger.

19. The system of claim 3, wherein the passenger provided no specific gender information during registration with the ridesharing platform.

20. A method comprising:
obtaining a dictionary comprising a mapping of each of a plurality of names to a gender of a plurality of genders and a frequency of each of the plurality of genders for each of the plurality of names;
receiving a trip order for the passenger;
determining a gender of the passenger based on:
if the dictionary comprises the mapping of a name of the passenger to a first possible gender of the plurality of genders, (i) the gender of a mapping of the name of the passenger to a gender of the plurality of genders,
else, (ii) the frequency of each of the plurality of genders of each of one or more names of the plurality of names within a threshold distance of the name of the passenger; and
determining a decision for the trip order based on the gender of the passenger.
